(19) United States
(12) Patent Application Publication
(10) Pub. No.: US 2025/0136213 A1
(43) Pub. Date: May 1, 2025

(54) ADJUSTABLE SEAT POST CONTROL

(71) Applicant: Jennifer Chen-Lee, Taichung City (TW)

(72) Inventor: Jennifer Chen-Lee, Taichung City (TW)

(21) Appl. No.: 18/420,772

(22) Filed: Jan. 24, 2024

(30) Foreign Application Priority Data
Oct. 27, 2023 (TW) 112211630

(51) Int. Cl. B62J 1/08

(52) U.S. Cl. CPC B62J 1/08; B62J 2001/085

(57) ABSTRACT

An adjustable seat post control is provided. The adjustable seat post control includes a connecting post, a limiting member, a transmission element, a routing tube, and an internal routing. The connecting post includes a first chamber penetrating from top to bottom and a first connecting thread. The limiting member is disposed in the first chamber. The transmission element is movably disposed in the first chamber, and has a limiting groove corresponding to the limiting member. The internal routing is disposed in the routing tube, and has an upper end exposed from the routing tube. The upper end of the internal routing is connected to the limiting member, a lower end of the internal routing extends to outside of the transmission element, and the transmission element has a push groove located at bottom end of the transmission element and corresponding to the upper end of the routing tube.

### FIELD OF THE DISCLOSURE

The present disclosure relates to the field of adjustable seat posts, and more particularly to the adjustable seat post control.

### BACKGROUND OF THE DISCLOSURE

Generally, adjustment to the seat post on bicycles is done manually and is quite inconvenient. In order to solve the inconvenience of traditional manual adjustment to the seat post, an adjustable seat post control was invented, so that the user only needs to press the controller handle to drive the steel cable to lift or drop the seat post. However, there are still disadvantages of the existing adjustable seat post control, such as the parts being too complex and cumbersome to assemble, and the screw-locked cable structure being prone to loosening.

Therefore, there is a need to explore a new technical solution to resolve the aforementioned issues.

### SUMMARY OF THE DISCLOSURE

In order to solve the above-mentioned defects and shortcomings of the conventional arts, the present disclosure provides an adjustable seat post control that has an easy accessory process, is simple to install, and is stable. Further, the adjustable seat post control of the present disclosure provides advantages such as tool-free installation, stable internal routing clamping at the control end, strong locking stability, and easy maintenance and adjustment.

The present disclosure provides an adjustable seat post control, including a connecting post, including a first chamber penetrates from top to bottom and a first connecting thread; a limiting member, disposed in the first chamber; a transmission element, movably disposed in the first chamber, and having a limiting groove corresponding to the limiting member; a routing tube; an internal routing, disposed in the routing tube, and having an upper end exposed from the routing tube; wherein the upper end of the internal routing is connected to the limiting member, a lower end of the internal routing extends to outside of the transmission element, and the transmission element has a push groove located at the bottom end of the transmission element and corresponding to the upper end of the routing tube.

In certain embodiments, the upper end of the internal routing has a mounting portion, and the limiting member has a mounting groove that matches with the mounting portion so that the mounting portion can be engaged in the mounting groove.

In certain embodiments, the connecting post has a side hole, and the limiting member can be disposed in the connecting post from the side hole; wherein each of the connecting post, the limiting member, and the transmission element has a routing slot for accommodating the internal routing.

In certain embodiments, the upper end of the routing tube has a tube cap located at the push groove.

In certain embodiments, further including a connecting member for connecting to a hydraulic rod, the connecting member has a second connecting thread corresponding to the first connecting thread, the connecting post is engaged with the connecting member to form a switch space, and the switch space is communicated with a connecting member hole for the hydraulic rod.

In certain embodiments, the first connecting thread is an external thread and the second connecting thread is an internal thread.

Compared with the conventional arts, the present disclosure has obvious advantages and beneficial effects. Specifically, the present disclosure provides an adjustable seat post control that is an easy accessory process, simple to install, and stable. Further, the adjustable seat post control of the present disclosure provides advantages such as tool-free installation, stable internal routing clamping at the control end, strong locking stability, and easy maintenance and adjustment.

### BRIEF DESCRIPTION OF THE DRAWINGS

The described embodiments may be better understood by reference to the following description and the accompanying drawings in which:

FIG. 1 is a perspective schematic view of an embodiment of the present disclosure;

FIG. 2 is a schematic perspective view of an embodiment of the present disclosure.

FIG. 3 is an exploded schematic view of an embodiment of the present disclosure.

FIG. 4 is an exploded schematic view of an embodiment of the present disclosure from another angle;

FIG. 5 is a sectional schematic view of line V-V of FIG. 1;

FIG. 6 is a sectional schematic view of an embodiment of the present disclosure in practice; and

FIG. 7 is a partially enlarged schematic view of FIG. 6.

### DETAILED DESCRIPTION OF THE EXEMPLARY EMBODIMENTS

The present disclosure is more particularly described in the following examples that are intended as illustrative only since numerous modifications and variations will be apparent to those skilled in the art.

It should be readily understood that the meaning of “on,” “above,” and “over” in the present disclosure should be interpreted in the broadest manner such that “on” not only means “directly on” something but also includes the meaning of “on” something with an element therebetween. When an element is said to be “connected” to another element, it can be directly connected to the other element or there may also be an intervening element in between, As used herein, the terms “vertical/vertically”, “horizontal/horizontally”, “left”, “right” and the like, are used herein for description to describe one element or feature's relationship to another element(s) or feature(s) as illustrated in the figures, and are not intended to be exhaustive or to limit the disclosure to the precise forms disclosed.

Unless otherwise defined, all terms used herein, including technical and scientific terms, have the same meanings as commonly understood by the ordinary skilled in the field to which the present disclosure belongs. The use of examples anywhere in this specification including examples of any terms is illustrative only, and in no way limits the scope and meaning of the present disclosure or of any exemplified term. It will also be understood that the term “and/or” as used herein refers to and encompasses any and all possible combinations of one or more of the associated listed items.

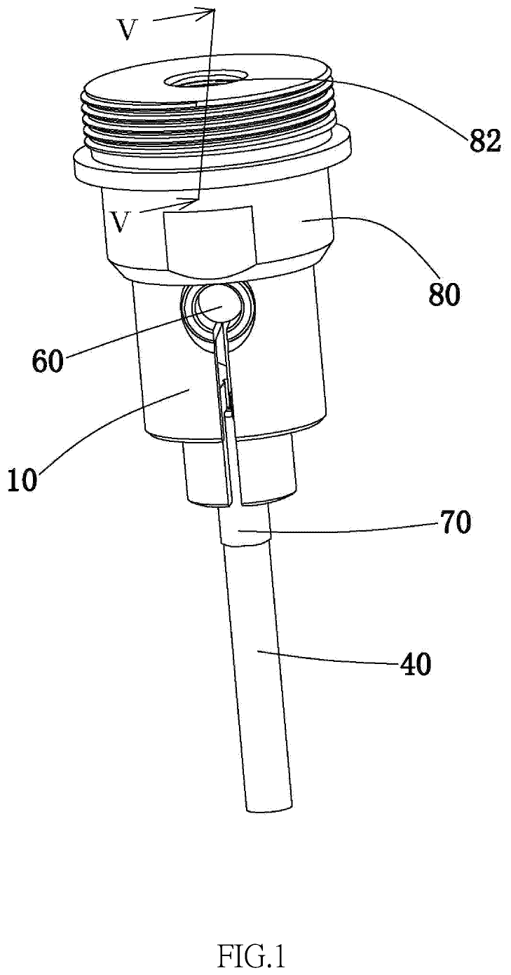

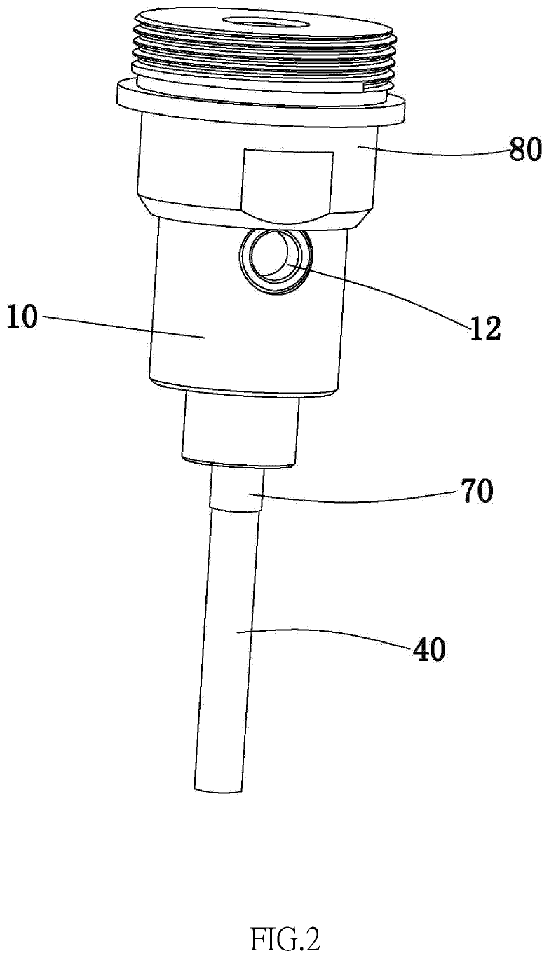

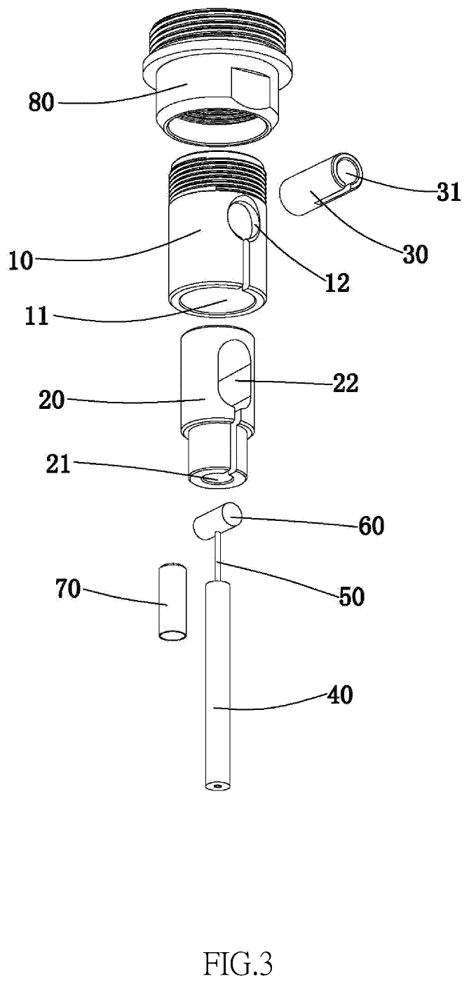

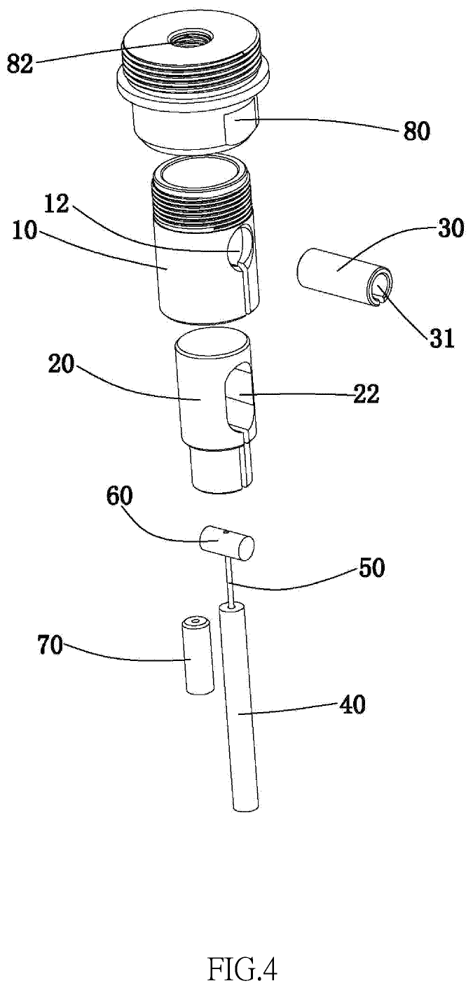

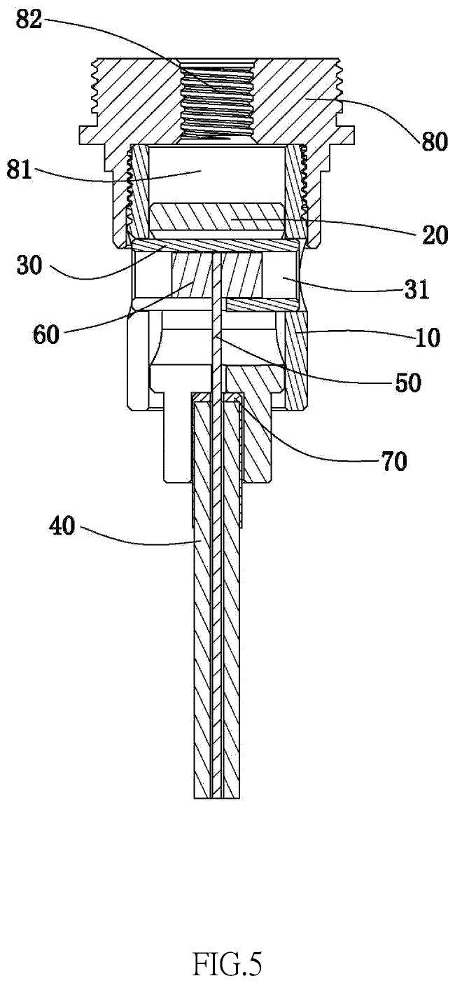

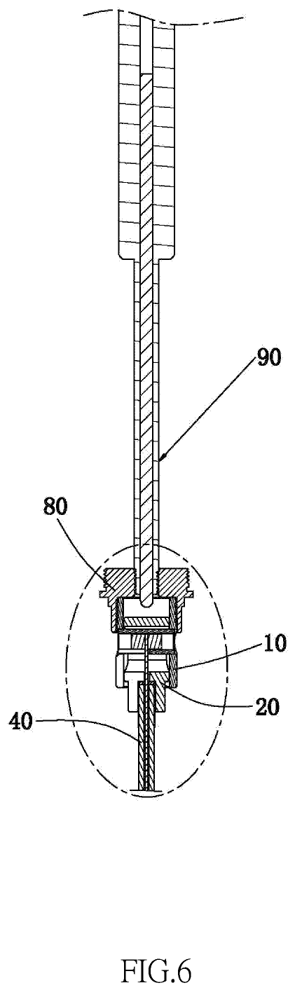

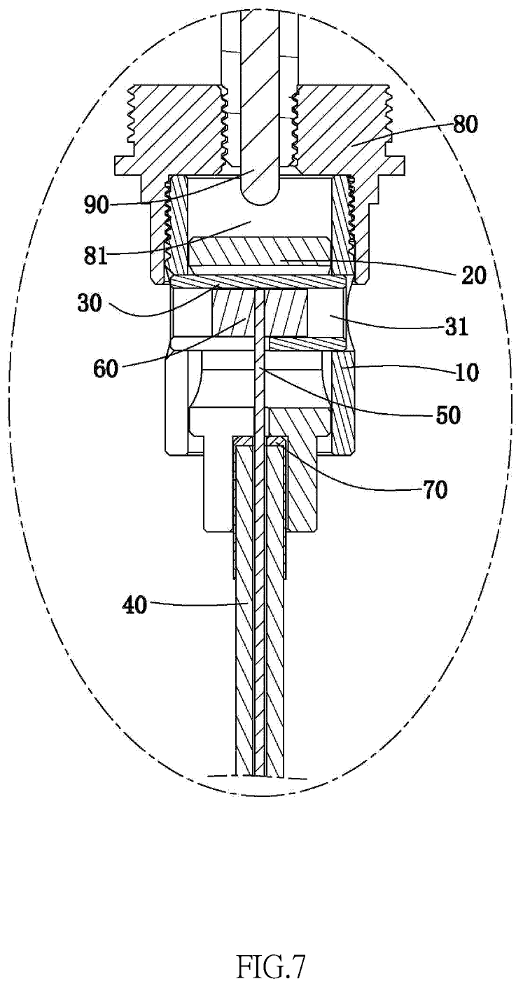

Referring to FIG. 1 to FIG. 7, the present disclosure provides an adjustable seat post control. The adjustable seat post control includes a connecting post 10, a limiting member 30, a transmission element 30, a routing tube 40, and an internal routing 50. The connecting post 10 includes a first chamber 11 penetrating from top to bottom and a first connecting thread. The limiting member 30 is disposed in the first chamber 11 horizontally (vertically relative to the first chamber 11). The transmission element 20 is movably disposed in the first chamber 11, and has a limiting groove 22 corresponding to the limiting member 30. The internal routing 50 is disposed in the routing tube 40, and an upper end of the internal routing 50 is exposed from the routing tube 40. In which, the upper end of the internal routing 50 is connected to the limiting member 30, a lower end of the internal routing 50 extends to outside of the transmission element 20, and the transmission element 20 has a push groove 21 located at the bottom end of the transmission element 20 and corresponding to the upper end of the routing tube 40.

In certain embodiments, the upper end of the internal routing 50 has a mounting portion 60, and the limiting member 30 has a mounting groove 31 matching with the mounting portion 60, so that the mounting portion 60 can be engaged in the mounting groove 31.

In certain embodiments, the connecting post 10 has a side hole 12, and the limiting member 30 can be disposed in the connecting post 10 from the side hole 12. Further, each of the connecting post 10, the limiting member 30, and the transmission element 20 has a routing slot for accommodating the internal routing 50.

In certain embodiments, the upper end of the routing tube 40 has a tube cap 70 located at the push groove 21.

In certain embodiments, the adjustable seat post control further includes a connecting member 80 connected with a hydraulic rod 90, the connecting member 80 has a second connecting thread corresponding to the first connecting thread, the connecting post 10 is engaged with the connecting member 80 to form a switch space 81, and the switch space 81 is communicated with a connecting member hole 82 for the hydraulic rod 90.

In certain embodiments, the first connecting thread is an external thread and the second connecting thread is an internal thread.

Generally, the internal routing 50 may be a steel wire cable.

The assembly steps of the present disclosure are briefly described.

Before installation, the connecting member 80 is individually connected to the hydraulic rod 90; S1, assembles the transmission element 20 into the connecting post 10 (the transmission element 20 and the connecting post 10 are engaged in a loose and movable relationship), and make the limiting groove 22 of the transmission element 20 correspond to the side hole 12 of the connecting post 10; then the limiting member 30 is inserted through the side hole 12, so that the limiting member 30 and the transmission element 20 are limited in the connecting post 10; Further, corresponds the notches of the routing slots (the routing slot of the internal routing) of the connecting post 10, the transmission element 20, and the limiting member 30 to complete the basic installation;

S2, threadedly engages the connecting post, 10 and the connecting member 80 which connected to the hydraulic rod 90;

S3, assembles the tube cap 70 to the upper end of the routing tube 40 to protect the routing tube 40, and the mounting portion 60 is die-cast to the upper end of the internal routing 50, and the internal routing 50 and the routing tube 40 are in a loose and movable relationship, and a routing control module is provided;

S4, when loading the adjustable seat post control on a bicycle for use, disposes the routing control module along the routing slot in step S1, and fittingly engages the mounting portion 60 in the limiter 30 to complete the assembly.

During riding, by pulling the internal routing 50, the routing tube 40 pushes the transmission element 20 to move up and down, and the upper end of the transmission element 20 opens or closes the switch space 81 for the hydraulic rod 90, so that the adjustable seat post can be lifted or dropped.

What is claimed is:

1. An adjustable seat post control, comprising:
a connecting post, including a first chamber penetrating from top to bottom and a first connecting thread;
a limiting member, disposed in the first chamber;
a transmission element, movably disposed in the first chamber, and having a limiting groove corresponding to the limiting member;
a routing tube;
an internal routing, disposed in the routing tube, and having an upper end exposed from the routing tube;
wherein the upper end of the internal routing is connected to the limiting member, a lower end of the internal routing extends to outside of the transmission element, and the transmission element has a push groove located at bottom end of the transmission element and corresponding to the upper end of the routing tube.

2. The adjustable seat post control according to claim 1, wherein the upper end of the internal routing has a mounting portion, and the limiting member has a mounting groove match with the mounting portion so that the mounting portion can be engaged in the mounting groove.

3. The adjustable seat post control according to claim 2, wherein the connecting post has a side hole, and the limiting member can be disposed in the connecting post from the side hole; wherein each of the connecting post, the limiting member, and the transmission element has a routing slot for accommodating the internal routing.

4. The adjustable seat post control according to claim 2, wherein the upper end of the routing tube has a tube cap located at the push groove.

5. The adjustable seat post control according to claim 1, further including a connecting member for connecting to a hydraulic rod, the connecting member has a second connecting thread corresponding to the first connecting thread, the connecting post is engaged with the connecting member to form a switch space, and the switch space is communicated with a connecting member hole for the hydraulic rod.

6. The adjustable seat post control according to claim 5, wherein the first connecting thread is an external thread and the second connecting thread is an internal thread.
